(19) United States
(12) Patent Application Publication
(10) Pub. No.: US 2025/0382226 A1
(43) Pub. Date: Dec. 18, 2025

(54) SUSTAINABLE CONCRETE

(71) Applicant: IDAHO STATE UNIVERSITY, POCATELLO, ID (US)

(72) Inventors: Chikashi Sato, POCATELLO, ID (US); John Dudgeon, POCATELLO, ID (US)

(21) Appl. No.: 19/236,420

(22) Filed: Jun. 12, 2025

Related U.S. Application Data
(60) Provisional application No. 63/659,030, filed on Jun. 12, 2024.

(51) Int. Cl. C04B 7/34; C04B 18/02; C04B 18/167; C04B 28/10; C04B 111/00; C04B 111/24; C04B 111/40

(52) U.S. Cl. CPC C04B 7/34; C04B 18/021; C04B 18/167; C04B 28/10; C04B 2111/00017; C04B 2111/24; C04B 2111/40

(57) ABSTRACT

In embodiments, the present disclosure is directed to cementitious materials and structures made therefrom. The cementitious materials may comprise precipitated calcium carbonate, such as one derived from an organic source. In embodiments, the present disclosure relates to submerged concrete structures comprising the cementitious material previously described.

### FIELD

The present subject matter relates generally to cementitious products and environmental remediation. Embodiments of the present disclosure relate to submersible cementitious products.

### BACKGROUND

Since the industrial revolution, human activities such as the burning of fossil fuels and deforestation have significantly increased atmospheric CO₂ levels. A large portion of this excess CO₂ is absorbed by the oceans.

When CO₂ dissolves in seawater, it reacts with water to form carbonic acid, which then dissociates into bicarbonate and hydrogen ions. The increase in hydrogen ions leads to lower pH levels, making the ocean more acidic. This chemical shift can reduce the availability of carbonate ions, which are essential for marine organisms like corals, mollusks, and some plankton to build their calcium carbonate shells and skeletons.

Ocean acidification poses serious threats to marine ecosystems, biodiversity, and food security. It can disrupt food chains, weaken coral reefs, and affect the reproductive and sensory abilities of marine species. As this process continues, it underscores the urgent need for reducing CO₂ emissions and enhancing ocean resilience.

### BRIEF DESCRIPTION

Aspects and advantages of the invention will be set forth in part in the following description, or may be apparent from the description, or may be learned through practice of the invention.

In one embodiment, a concrete structure is provided. The concrete structure comprises a cementitious material comprising a precipitated calcium carbonate.

In another embodiment, a method of localized remediation of ocean acidification is provided. Generally, the method comprises using concrete structures comprising a cementitious material comprising precipitated calcium carbonate as submersed concrete structures.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIGS. 1A and 1B show the increase in pH of acidic sea water when exposed to PCC concrete, as well as the increase in alkalinity of the acidic sea water when exposed to PCC concrete, both in comparison to regular concrete;

FIG. 2 shows the decrease in pH of basic sea water when exposed to PCC concrete as compared to regular concrete;

FIGS. 3A-3F show the concentration of various cationic species in regular concrete and PCC concrete as a control, when exposed to DI water, when exposed to sea water and when exposed to acidic sea water;

FIGS. 4A-4D show the concentration of various cationic species in regular concrete and PCC concrete as a control, when exposed to DI water, when exposed to sea water and when exposed to acidic sea water;

FIGS. 5A-5D show the concentration of various cationic species in regular concrete and PCC concrete as a control, when exposed to DI water, when exposed to sea water and when exposed to acidic sea water; and

FIGS. 6A-6N show the concentration of various cationic species in the water samples that the regular concrete and PCC concrete were exposed to.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation such as “generally,” “about,” or “approximately” include values within ten percent greater or less than the stated value. When used in the context of an angle or direction, such terms include within ten degrees greater or less than the stated angle or direction, e.g., “generally vertical” includes forming an angle of up to ten degrees either clockwise or counterclockwise with the vertical direction V.

The detailed description uses numerical and letter designations to refer to features in the drawings. Like or similar designations in the drawings and description have been used to refer to like or similar parts of the invention. As used herein, the terms “first,” “second,” and “third” may be used interchangeably to distinguish one component from another and are not intended to signify location or importance of the individual components.

The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of the present disclosure include cementitious materials, products made from such materials, and methods of making such products. Disclosed herein are cementitious materials which may be used in products such as concrete. For example, materials according to the present disclosure may be used in conventional concrete, ready mix, pre-cast, shotcrete, and various other forms. The presently described cementitious materials may be used in the fabrication of concrete structures. While these concrete structures are not particularly limited in their use, they may be used in marine environments. As will be described in full detail in the coming paragraphs, the present inventors have found that the concrete structures of the present disclosure may be useful as structures used in marine environments for their effect on acidic sea water.

In general, a concrete mixture comprises cementitious material and aggregate, e.g., fine aggregate (e.g., sand) or coarse aggregate (e.g., rocks or gravel). In forming the concrete, the cementitious material is mixed with water to initiate a hydration reaction which, over time, releases heat, binds or confines the water, and ultimately dries and hardens to form a finished product which may be used in various structures or materials (the overall process of mixing the cement with water and then allowing the hydration reactions to carry out until a dry, solid product is formed is generally referred to as setting or curing). A concrete mixture may also include other materials such as supplementary cementitious materials or admixtures.

The water which is incorporated into mixes according to the present disclosure may include a variety of types of water from a variety of sources. For example, the water may be potable water or otherwise treated water. Also, by way of example, the water may be recycled water, gray water, collected runoff, or wastewater. Wastewater may be derived from municipal and/or industrial sources, such as the wastewater may be or may include process water. In various embodiments, any one or more of such water types or combinations thereof may be included.

The cementitious material according to the present disclosure includes Precipitated Calcium Carbonate (PCC) derived from a plant matter processing byproduct, an example of such plant matter being sugar beets. The PCC may also be referred to as Carbonation Lime Residue (CLR). As mentioned, the PCC may be derived from a plant matter processing byproduct. For example, byproducts and wastes from beet sugar production may include a lime sludge. The lime sludge may be settled and the precipitate generated thereby may provide PCC for cement products, such as cementitious material which may be used in, for example, concrete or soil-cement. As another example, sugarcane bagasse ash produced from cane sugar can also be used to replace a portion of cement in concrete and like products. Cement and related products (e.g., concrete, soil cement, and the like) which include components derived from sugar manufacturing, such as the PCC described herein, may also be referred to as sweetcrete.

PCC according to the present disclosure, e.g., which is derived from plant matter, may include a high concentration of calcium carbonate (CaCO₃), and such concentration may indicate the binding capacity in PCC. The second most prevalent constituent in the PCC may be quartz (SiO₂). The concentrations of calcium carbonate and quartz may be measured or determined, for example, using X-ray Diffraction (XRD) to analyze the crystallographic structure of the material. For example, the elemental composition of the PCC may include between about 25% and about 55% oxygen by weight, such as between about 30% and about 50% oxygen by weight, such as between about 35% and about 45% oxygen by weight, such as about 40% oxygen by weight, such as 39.4% oxygen by weight. Also by way of example, the elemental composition of the PCC may include between about 30% and about 60% calcium by weight, such as between about 35% and about 55% calcium by weight, such as between about 40% and about 50% calcium by weight, such as about 45% calcium by weight, such as 45.9% calcium by weight. Further by way of example, the elemental composition of the PCC may include between about 2% and about 20% carbon by weight, such as between about 5% and about 15% carbon by weight, such as about 10% carbon by weight, such as 9.2% carbon by weight. For example, such composition of the PCC may be measured or determined using known techniques such as X-ray diffraction analysis (XRD), scanning electron microscopy (SEM), or energy dispersive X-ray spectrometry. The PCC may be in powder or granular form with particle sizes up to about 1 in., such as up to about 0.5 in. Such PCC may also be characterized by an irregular, sub-angular to sub-rounded morphology, e.g., which may be identified using scanning electron microscopy. Further, it is to be understood that precipitated calcium carbonate derived from plant matter is distinct from other types of precipitated calcium carbonate, e.g., rock-derived materials, such as marble powder from carbonate rocks.

Referring again to the example of a concrete mixture, the concrete mixture may include a hydraulic cement, e.g., Portland cement. Portland cement may be manufactured by, e.g., crushing, milling and proportioning the following materials: lime or calcium oxide (CaO, such as from limestone, chalk, shells, shale or calcareous rock), silica (SiO₂, e.g., from sand, old bottles, clay or argillaceous rock); alumina (Al₂O₃, e.g., from bauxite, recycled aluminum, or clay); iron oxide (Fe₂O₃, e.g., from clay, iron ore, scrap iron, or fly ash); and gypsum (CaSO₄·2H₂O, which may be found together with limestone). Such materials, without the gypsum, are proportioned to produce a mixture with the desired chemical composition and then ground and blended by one of two processes—dry process or wet process. The materials are then fed through a kiln at high temperatures (e.g., about 2,600° F.) to produce grayish-black pellets known as clinker. The alumina and iron act as fluxing agents which lower the melting point of silica, e.g., from about 3,000° F. to about 2,600° F. After this stage, the clinker is cooled and pulverized, and the gypsum is added to regulate setting time. The mixture is then ground extremely fine to produce cement. Hydraulic cement derives its strength from chemical reactions between the cement and water, which process is referred to as hydration. Hydration of hydraulic cement into secondary components provides strength to the resulting concrete according to the known chemical reactions during hydration.

Cement hydration includes a series of reactions over a plurality of stages. Such stages include, in chronological order, an initial mixing reaction, dormancy, strength acceleration, speed reduction, and steady development. The initial mixing reaction occurs upon adding water to cement, whereupon the cement particles dissolve. The dissolved particles release ions and initiate the formation of hydration products. This phase starts the chemical process for subsequent reactions to occur. The dormancy stage, where the hydration process may appear to stall, follows the initial reaction. During the dormancy stage, further chemical reactions of the hydration process continue, albeit at a slower pace than the initial mixing reaction. During the strength acceleration stage, the hydration process occurs more rapidly and there is a noticeable increase in strength development. Hydration products like the calcium silicate hydrate (C—S—H) gel and calcium hydroxide (CH) begin to form more extensively, enhancing the strength of the material. Once the initial acceleration in strength development occurs, the rate of reaction gradually decreases, i.e., the hydration process continues but with a slowing down of the chemical reactions, hence the speed reduction stage. The final phase is the steady development stage, during which the process continues with steady and continuous development. Accordingly, the strength of the cement or concrete, in particular the compressive strength, generally increases along an asymptotic curve. The speed reduction stage generally occurs after around twenty eight days of curing time. For example, cement typically achieves about 90% to 95% or more of its ultimate strength at or about twenty eight days of curing. Thus, strength testing is usually performed at intervals within the twenty-eight day time period after initial mixing, up to and including at day twenty eight.

As mentioned, the concrete mixture may further include aggregates, such as coarse or fine aggregates. The type and quantity of aggregate may be selected based on the desired properties for the end use of the concrete. For example, a fine aggregate such as sand may be used in concrete for sidewalks. As another example, concrete for structural uses, such as in a wall, column, or other similar structural element, may include coarse aggregates, e.g., gravel, as well as or instead of fine aggregates.

The aggregate may be or may include a Recycled Concrete Aggregate (RCA), such as remnants from demolished concrete and returned concrete from ready mix. The demolished concrete may be old concrete that has already been used for construction and return concrete may be leftover concrete from ready-mix concrete trucks. Such concrete may be recycled such as by crushing and removing unwanted materials (e.g., rebar, wood, paper, gypsum, asphalt, paint, etc.). The concrete may be crushed using crushers such as jaw-type crushers and impact crushers to reduce the size of the concrete pieces to a range which is suitable for use as aggregate in new concrete, such as coarse aggregate.

Impurities often remain in the recycled concrete after the foregoing processes. Accordingly, some recycled concrete is further treated to improve suitability for various end uses. Recycled concrete which has undergone such further treatment is typically referred to as Upcycled Concrete Aggregate (UCA). Such further treatments may include eliminating or strengthening adhered mortar, e.g., removing by grinding, heating, pre-soaking in water, or pre-soaking in acids. Other upcycling techniques to increase the strength of RCA are polymer emulsion, pozzolan slurry, calcium carbonate bio-deposition, sodium silicate solution, and carbonation. Thus, in one example, UCA may be produced by treating RCA with mild acid in a carbon capture and mineralization process.

As mentioned above, embodiments of the present disclosure include cementitious materials and products made from such materials. The cementitious material may include a cement and precipitated calcium carbonate derived from plant matter. The concrete may further include water and an aggregate. The precipitated calcium carbonate derived from plant matter may make up about 40 wt. % of the cementitious material. In some embodiments, the precipitated calcium carbonate derived from plant matter may make up about 40 wt. % of the cementitious material or greater, such as greater than 50 wt. %, such as greater than 60 wt. %. Defined in terms of ranges, precipitated calcium carbonate derived from plant matter may make up from 40 wt. % to 80 wt. % of the cementitious material, such as from 45 wt. % to 75 wt. % of the cementitious material, such as from 50 wt. % to 70 wt. % of the cementitious material, such as between 55 and 65 wt. % of the cementitious material.

Thus, as compared to conventional concrete, up to about 80 wt. % percent of the cement, e.g., Portland cement, may be replaced with precipitated calcium carbonate derived from plant matter, e.g., from beet sugar waste product, such as derived from lime sludge as described above.

The precipitated calcium carbonate derived from plant matter differs from other precipitated calcium carbonate products, such as precipitated calcium carbonate from powdered rocks or precipitated calcium carbonate produced using trapped CO₂ gas, in terms of color as well as the amounts of calcium and other minerals. For example, the precipitated calcium carbonate derived from plant matter may include between about 30% and about 60% calcium by weight. The precipitated calcium carbonate comprises a powder or granular material having an irregular, sub-angular to sub-rounded morphology. Those of ordinary skill in the art will recognize that such morphology may be determined using known techniques, such as SEM.

Concrete structures can be formed from the cementitious materials and aggregates as described above. While these concrete structures are not particularly limited, they may include breakwaters, such as tetrapods, dolos or reef balls. Furthermore, structures such as wharves, piers, jetties, seawalls, revetments or mooring blocks may comprise the concrete of the present disclosure.

Without wishing to be bound to any particular theory, the present inventors have found that concrete structure comprising high contents of precipitated calcium carbonate derived from plant matter can serve to increase alkalinity, and thereby buffering capacity, of sea water. The increased content of calcium within the concrete structure comprising precipitated calcium carbonate may allow for greater dissolution of calcium ions into ocean water as compared to regular concrete. Without wishing to be bound to any particular theory, greater formation of calcium hydroxide can lead to an increase in the release of hydroxide ions and calcium ions, thereby strengthening the carbonate buffer via an increase in alkalinity.

Additionally, it may be advantageous for the concrete structures of the present disclosure to have an increased porosity. The increased porosity of the concrete can be obtained through a variety of means, such as, but not limited to, increased water to cement ratios or increased coarse aggregate to fine aggregate ratios. For instance, where a typical concrete may be formed with a water to cement ratio of 0.4 to 0.6, concretes of the present disclosure may utilize a water to cement ratio of greater than 0.5 by weight, such as greater than 0.6 by weight, such as greater than 0.7 by weight, such as greater than 0.8 by weight. In terms of ranges, concretes of the present disclosure may make use of a water to cement ratios of between 0.7 and 1 by weight, such as between 0.7 and 0.9 by weight.

Additionally, the ratio of coarse aggregate to fine aggregate may be increased. While the ratio of coarse aggregate to fine aggregate may typically be 1:1 to 2:1 by volume, concretes of the present disclosure may utilize a coarse to fine ratio of greater than 2:1 by volume, such as greater than 3:1 by volume, such as greater than 4:1 by volume, such as greater than 5:1 by volume. In terms of ranges, concretes of the present disclosure may utilize a coarse to fine ratio of between 3.5:1 by volume and 5:1 by volume, such as between 4:1 by volume and 4.5:1 by volume.

The porosity of the rough aggregate may additionally be adjusted. For instance, the rough aggregate may have an average porosity of between 30% and 70%, such as between 40% and 60%, as determined by helium pycnometry. Such coarse aggregates may comprise volcanic rock, andesite or lapilli tuffs.

By varying the ratios of the water to cement ratio or coarse to fine aggregate ratio, the porosity of the final concrete structure can be controlled. For instance, the porosity of the concrete products of the present disclosure can be between 20% and 35%, so as can be determined by methods known in the art, such as helium pycnometry.

### Examples

While certain embodiments of the disclosed subject matter have been described using specific terms, such description is for illustrative purposes only, and it is to be understood that changes and variations may be made without departing from the spirit or scope of the subject matter.

PCC concrete samples were formed by mixing water, Portland cement, PCC, coarse aggregate and fine aggregate in a mixer to form a mixture. Of the cementitious materials (Portland cement and PCC), the PCC had a weight percentage of 25 wt. %. The mixture was then formed in 2 inch cubes, and allowed to set and dry. The exterior of the cubes were then analyzed by SEM-EDS (scanning electron microscopy-energy dispersive x-ray spectroscopy) to obtain data regarding the composition of the PCC concrete before exposure to any water. Thereafter, concrete cubes (including both PCC concrete samples and regular concrete control samples) were placed into individual containers containing two liters of: DI water, sea water, and sea water with injected CO₂, so as to make the seawater acidic. For the present experiments, artificial sea water was formed according to Kester et al. (1967).

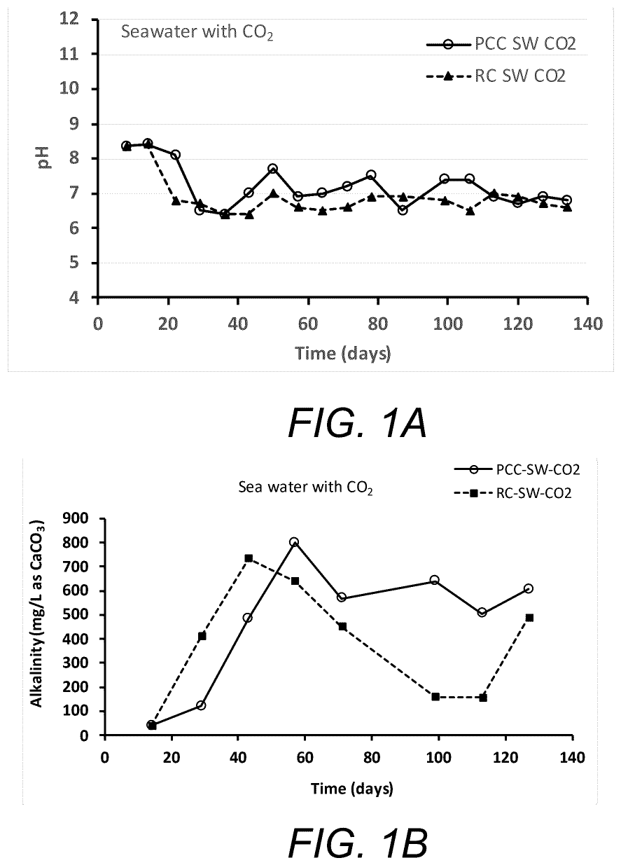

Turning now to FIG. 1A, it can be seen the pH of sea water with CO₂ injected was higher for the sample containing PCC concrete as compared to the sample containing regular concrete. FIG. 1B, similarly, shows that the sample containing the PCC concrete had a higher degree of alkalinity as compared to the regular concrete. The higher degree of alkalinity in the PCC sample may allow for the sea water to have a greater buffering capacity.

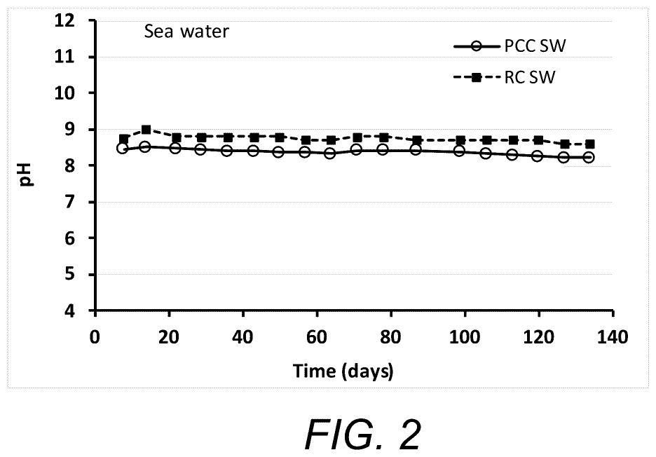

FIG. 2 shows that in cases where the seawater is initially basic, or where basicity is elevated due to interaction with regular concrete, PCC concrete can lead to a reduction in pH, so as to maintain the pH at more ecologically favorable levels. For instance, while regular concrete can release hydroxides ions through the ionization of calcium hydroxide, PCC concretes of the present disclosure can also release carbonate ions into sea water. The released carbonate ions can strengthen the bicarbonate buffer system. This is shown, at least in part, to the increased alkalinity of PCC-seawater systems as shown in FIG. 1B. Specifically, FIG. 2 shows that the pH (˜8.7) remained relatively the same for the regular concrete sample, and decreased to a pH of ˜8.36 for the PCC sample.

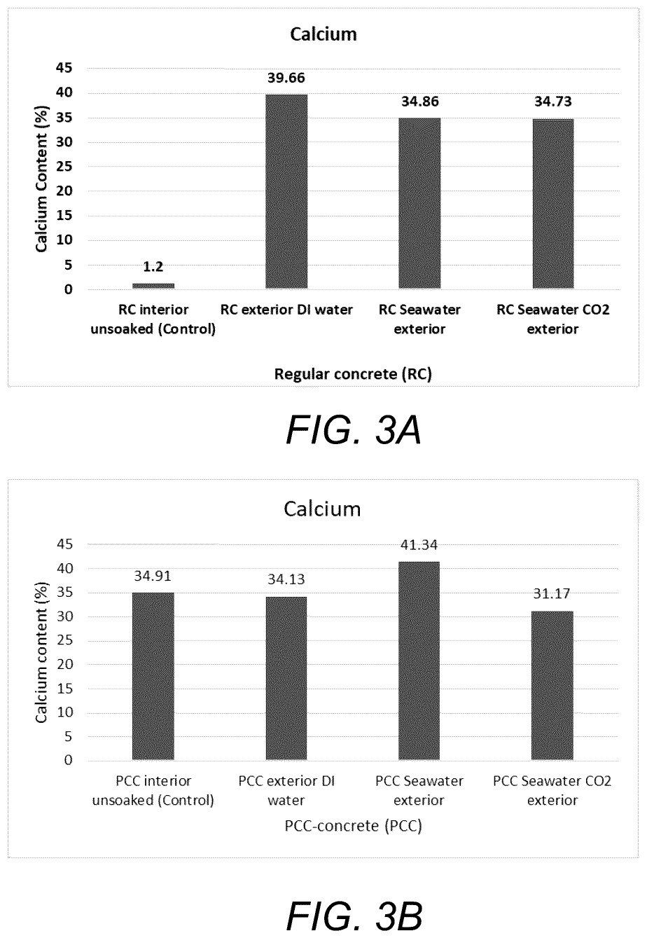

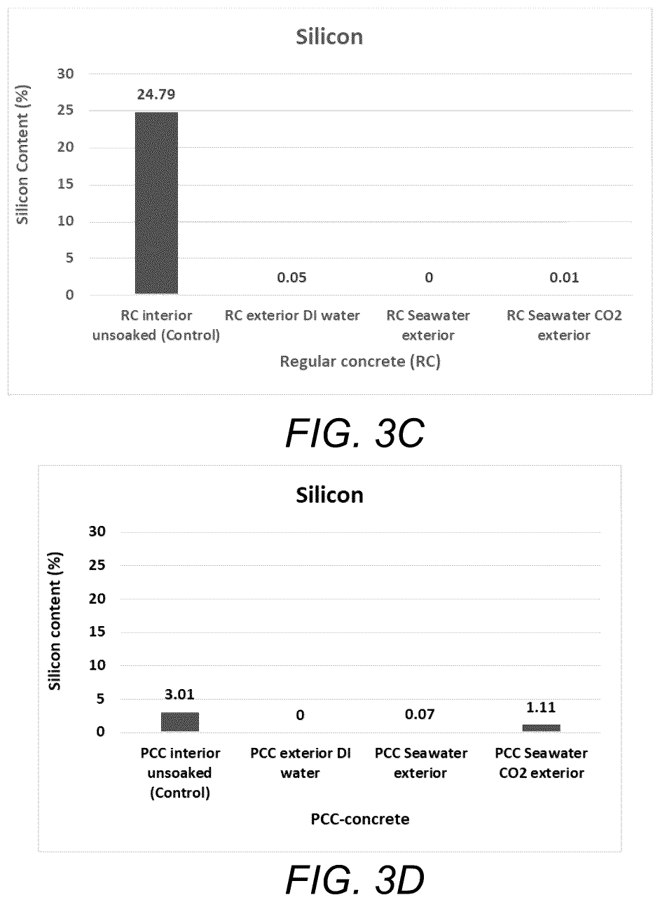

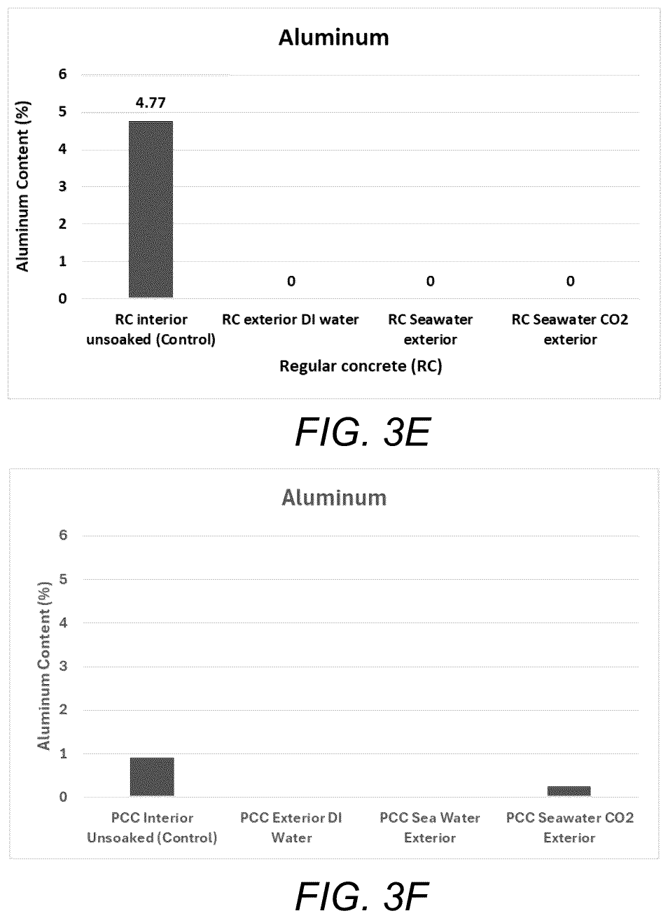

Without wishing to be bound to any particular theory, the increase in buffering capacity observed in sea water samples containing PCC concrete may be attributable to the increased content of calcium in PCC concrete. FIG. 3A shows the calcium content as a % of the concrete sample when unsubmerged, submerged in DI water, submerged in sea water, and submerged in acidic seawater. As can be seen by the relative increase in % calcium, when the concrete sample is submerged in any water, other ionic species within the concrete sample dissolve into the water at a greater rate than calcium. In contrast to this, it can be seen from the graph in FIG. 3B that the PCC sample did not significantly change in wt. % calcium, indicating that the calcium dissolved out of the concrete sample at a rate roughly equal to the sum of other ionic species in the concrete sample.

FIGS. 3C and 3D may be able to account for some of the increase in the (relative) calcium content as seen in FIG. 3A. Specifically, the regular concrete sample as shown in FIG. 3A contained 24.79% of silicon when dry. When exposed to any water, this silicon content dropped dramatically, indicating that much of the silicon dissolved in to the water. Comparatively, the PCC concrete sample shown in FIG. 3D had relatively little silicon to begin with, at only 3% silicon.

FIGS. 3E and 3F may be able to account for some of the increase in the (relative) calcium content as seen in FIG. 3A. Specifically, the regular concrete sample as shown in FIG. 3A contained 4.77% of aluminum when dry. When exposed to any water, this aluminum content dropped dramatically, indicating that much of the aluminum dissolved into the water. Comparatively, the PCC concrete sample shown in FIG. 3D had relatively little aluminum to begin with, at a little under 1% aluminum.

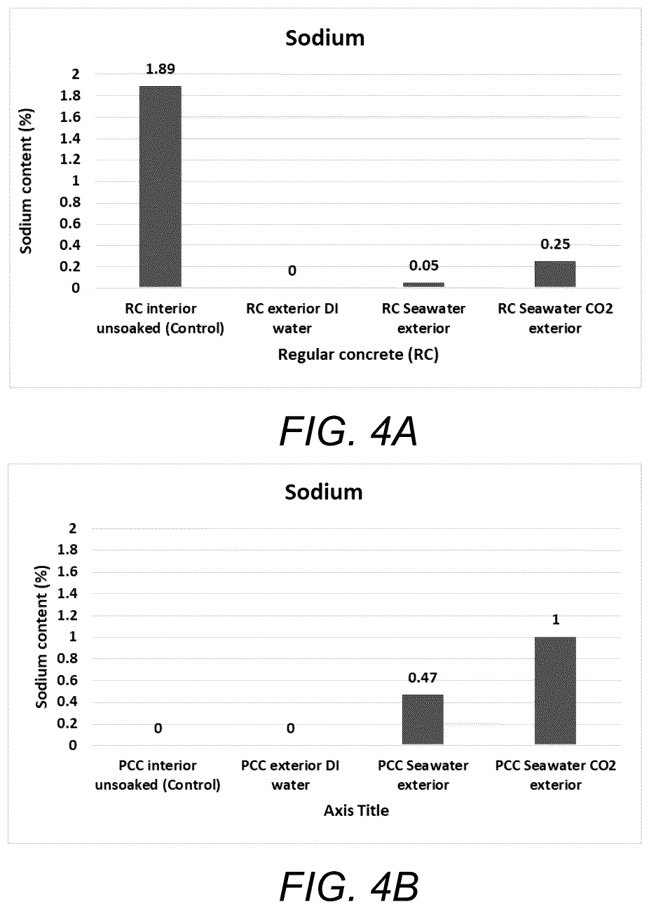

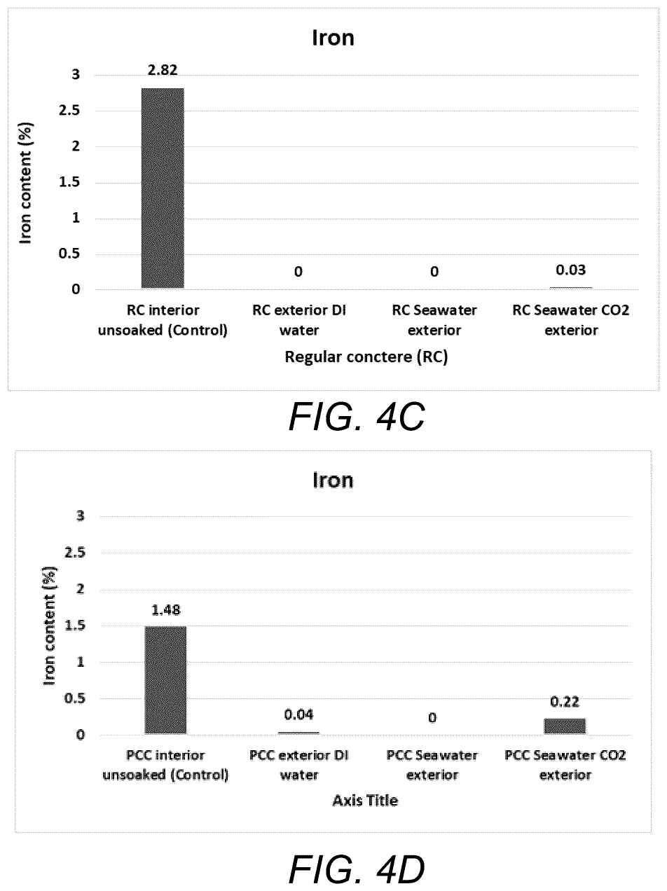

FIG. 4A shows that the regular concrete comprised 1.89% sodium when dry. Most of the sodium in the regular concrete dissolved into the water, with some being retained in the salt water species. FIG. 4B shows that the PCC concrete contained very little sodium to begin with, though some sodium from the sea water did become adsorbed on to the surface of the PCC concrete.

Similar to the silicon and aluminum as described in FIGS. 3A, 3B, 3C and 3D, FIGS. 4C and 4D show that the regular concrete had a higher content of iron than the PCC concrete, the greater dissolution of which may have led to the relatively large increase in calcium content as observed in FIG. 3A.

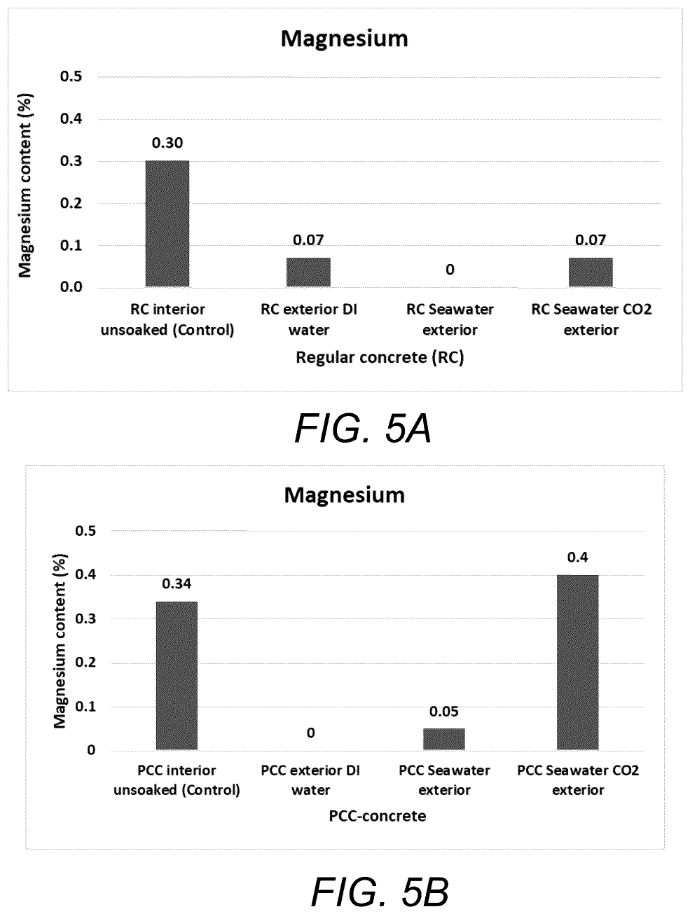

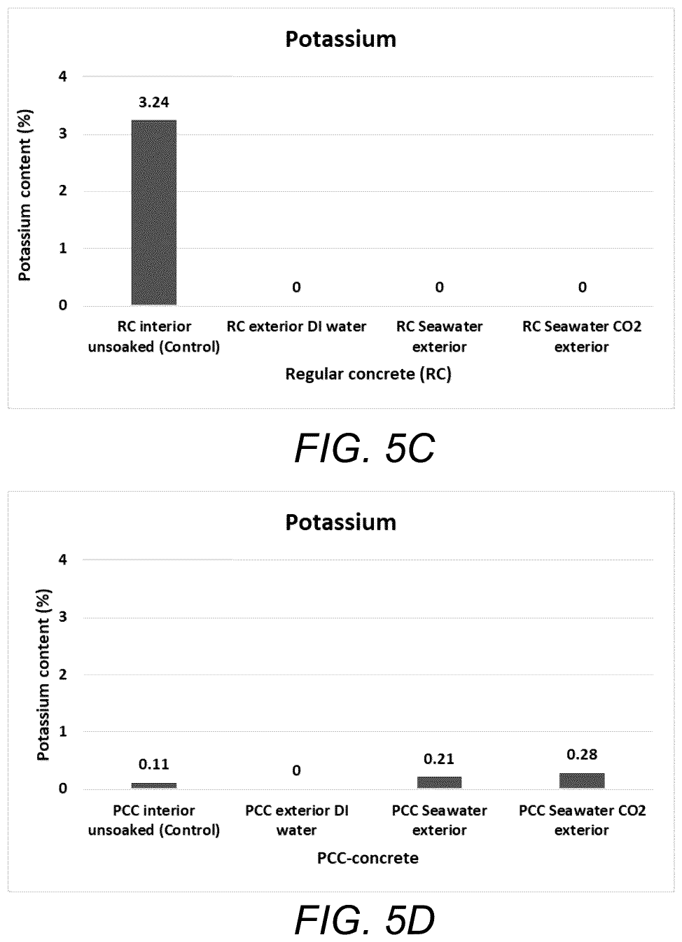

FIGS. 5A and 5B show that the amount of magnesium in the regular concrete and the PCC concrete were relatively the same, with the PCC concrete experiencing minimal dissolution of magnesium under the acidic sea water conditions.

As above with the silicon in FIG. 3A, the potassium content in the regular concrete was significantly higher than the PCC concrete. The regular concrete lost a significant % of potassium, possibly leading to the increase in relative calcium content observed in FIG. 3A.

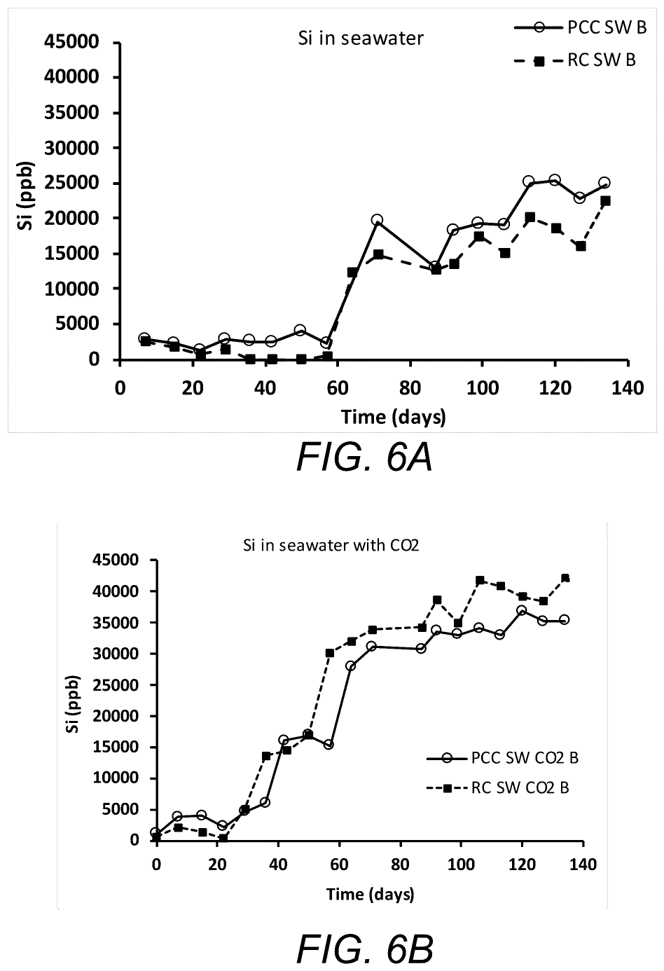

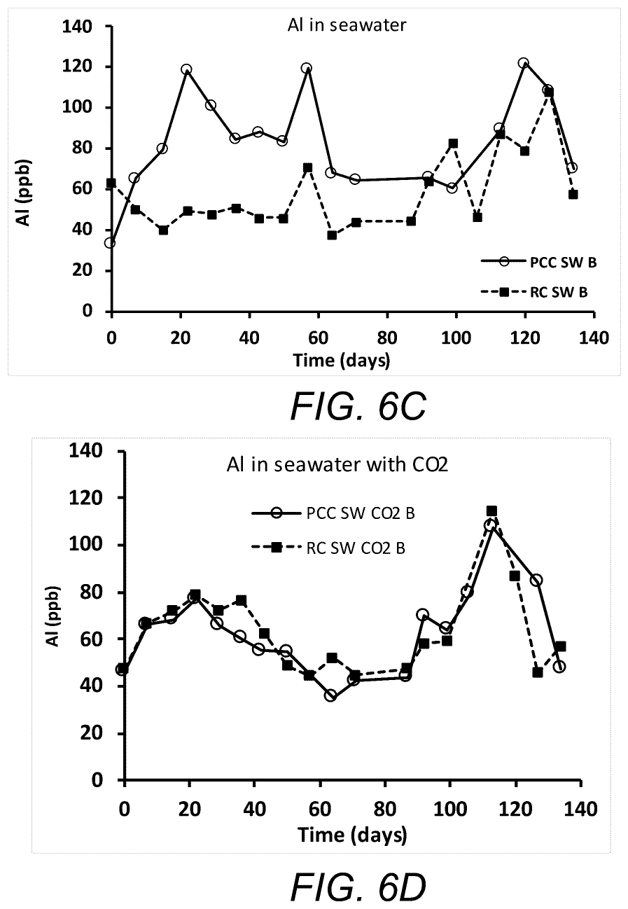

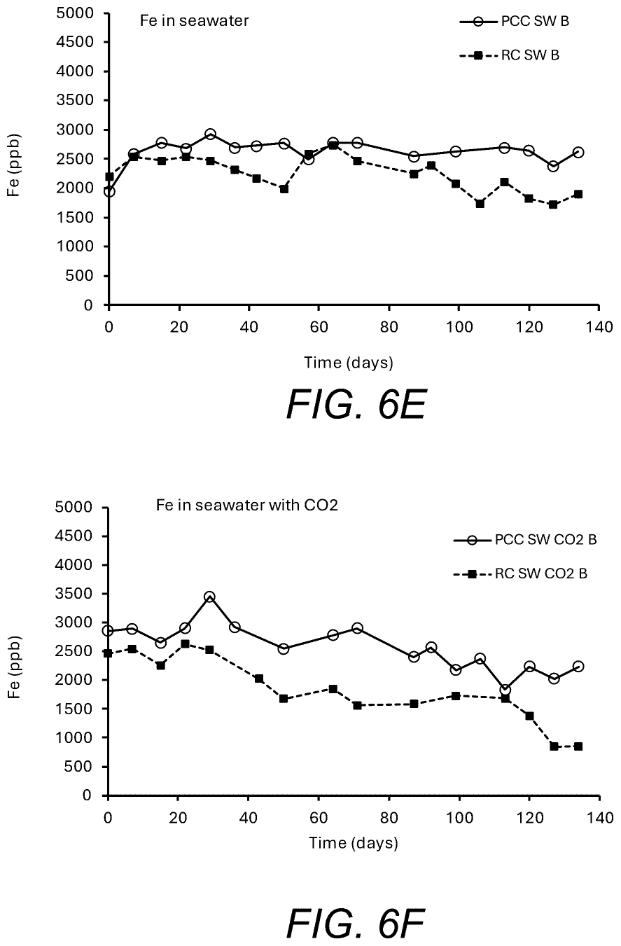

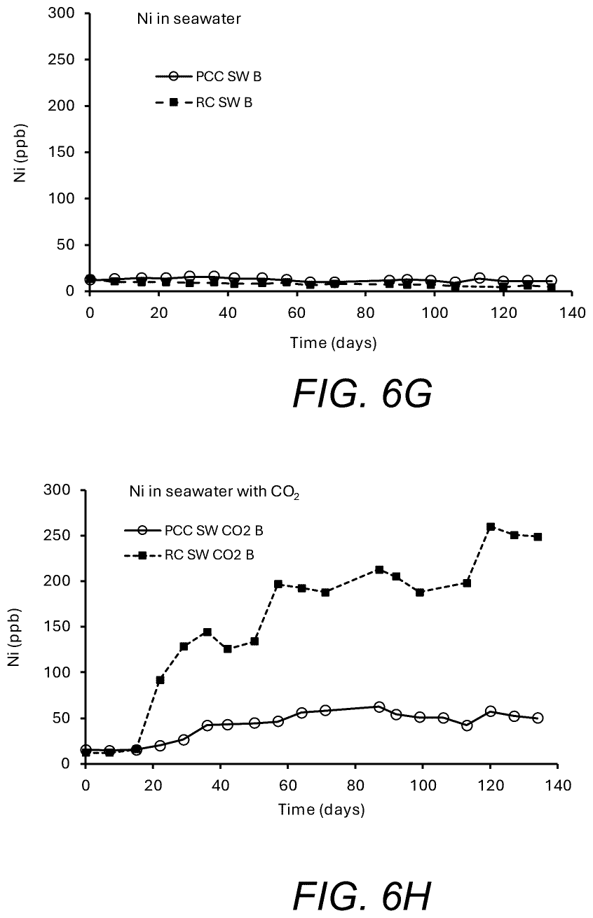

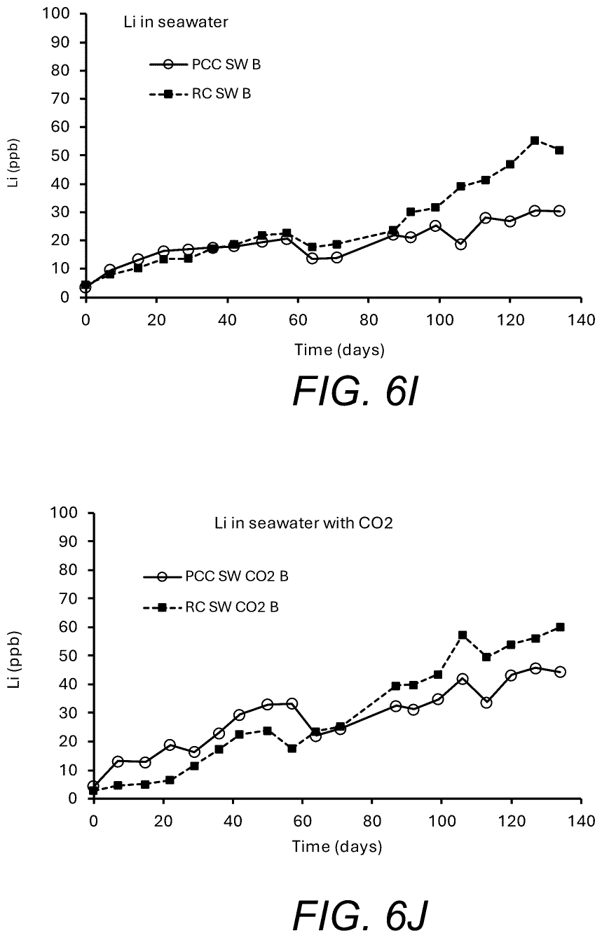

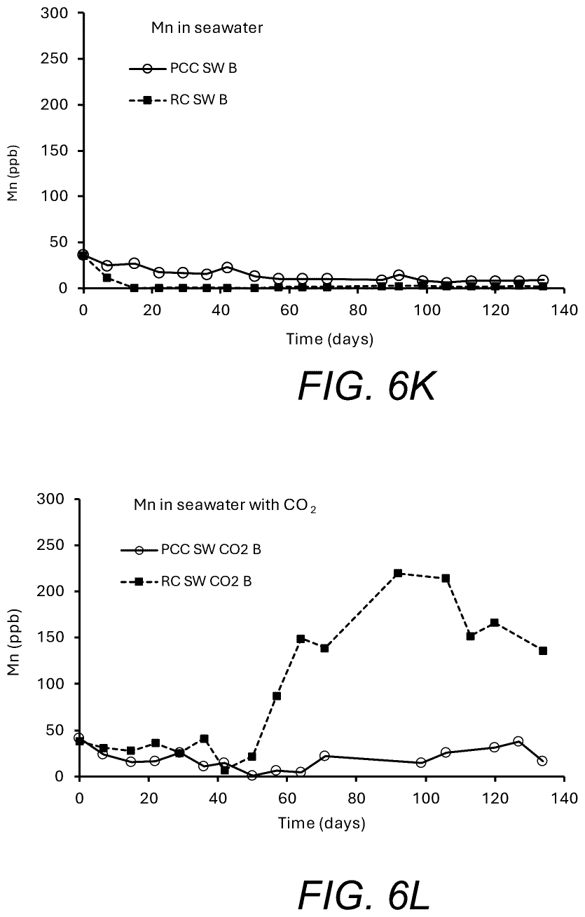

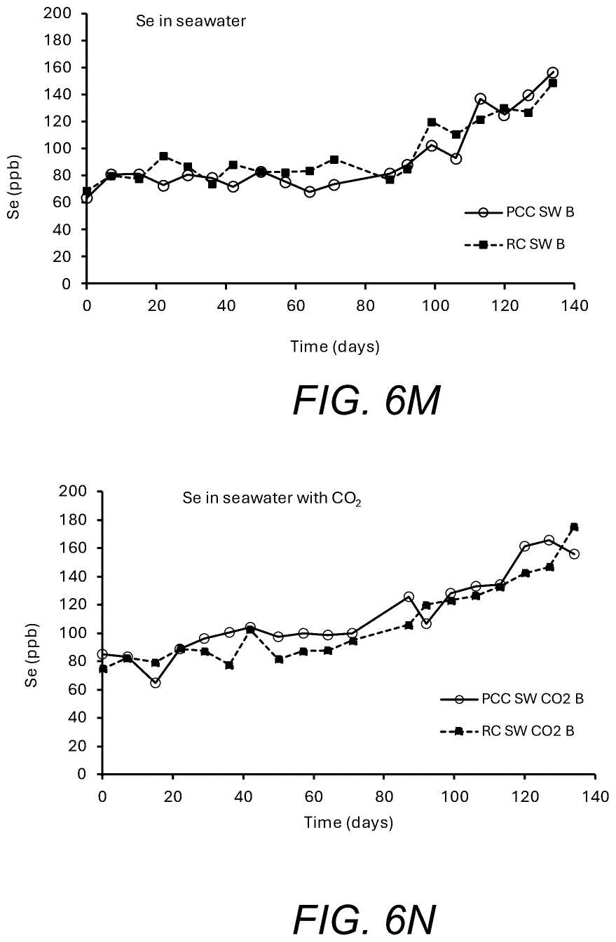

Measurements were additionally made on the samples of water in which the two concrete samples were submerged. As can be seen in FIG. 6A, the seawater sample with the PCC concrete had a higher content of silicon as compared the regular concrete. Without wishing to be bound to any particular theory, it is believed that the silicon present in the regular concrete samples form insoluble precipitates at a greater rate, leading to the PCC sample appearing to have leached a greater amount of silicon than the regular concrete. FIG. 6B shows that the content of silicon in acidic sea water was higher for the regular concrete sample as compared to the PCC sample. As can be seen in FIG. 6C, the seawater sample with the PCC concrete had a higher content of aluminum as compared to the regular concrete. Similar to FIG. 6A with respect to silicon, it is believed that the increased concentration of aluminum in the PCC seawater sample shown in FIG. 6C may be due to the aluminum in the regular concrete forming insoluble precipitates to a greater degree than the PCC concrete. FIG. 6D shows that the aluminum content in the acidic sea water was roughly equal between the regular concrete and PCC concrete samples. FIG. 6E shows that sea water had a higher content of iron when exposed to PCC concrete as compared to regular concrete. FIG. 6F shows that concentration of iron in the acidic sea water was significantly higher for the PCC concrete sample as compared to the regular concrete sample. FIG. 6G shows that, in regular sea water, the concentration of nickel was roughly equal between the PCC sample and regular concrete sample. However, as shown in FIG. 6H, the concentration of nickel in the acidic sea water for the regular concrete sample was greatly higher than in the acidic sea water of the PCC sample. FIGS. 61 and 6J show that in both regular sea water and acidic sea water, lithium content was higher for the regular concrete samples as compared to the PCC samples. FIG. 6K shows that, in regular sea water, the PCC concrete sample produced a slightly higher concentration of manganese over the regular concrete. However, as shown in FIG. 6L, the concentration of manganese in the acidic sea water was greatly higher for the regular concrete sample than in the PCC concrete sample. With respect to FIGS. 6M and 6N, it can be seen that no significant difference in the concentration of selenium in the regular sea water and acidic sea water can be observed.

Thus, when the concrete structures of the present disclosure are used in oceanic environments, a localized increase in pH and alkalinity may be observed. As described in the Background above, ocean acidification has several deleterious effects, such as straining marine ecosystems and weakening of coral reefs. Thus, the PCC concretes of the present disclosure may be useful for near-shore remediation of ocean acidification.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A concrete structure comprising concrete, wherein the concrete comprises a cementitious mixture comprising greater than 50% precipitated calcium carbonate.

2. The concrete structure of claim 1, wherein the cementitious mixture comprises greater than 60 wt. % of the upcycled precipitated calcium carbonate.

3. The concrete structure of claim 1, wherein the precipitated calcium carbonate is derived from organic matter.

4. The concrete structure of claim 1, further comprising coarse aggregate and fine aggregate.

5. The concrete structure of claim 4, wherein the concrete structure has a ratio of the coarse aggregate to the fine aggregate of greater than 3:1 by volume.

6. The concrete structure of claim 4, wherein the coarse aggregate has a porosity between 40% and 60%.

7. The concrete structure of claim 4, wherein the coarse aggregate further comprises recycled concrete aggregate.

8. The concrete structure of claim 1, wherein the concrete structure has porosity between 20% and 35%.

9. A concrete slurry comprising a cementitious mixture, water, and aggregates, wherein the cementitious mixture comprises greater than 50 wt. % of precipitated calcium carbonate.

10. The concrete slurry of claim 9, wherein the aggregates comprise coarse aggregates and fine aggregates.

11. The concrete slurry of claim 10, wherein the concrete slurry has a ratio of the coarse aggregate to the fine aggregate of greater than 3:1 by volume.

12. The concrete slurry of claim 9, wherein the concrete slurry has a ratio of the cementitious mixture to the water of greater than 0.7.

13. The concrete slurry of claim 10, wherein the coarse aggregate has a porosity between 40% and 60%.

14. The concrete structure of claim 1, wherein the concrete structure comprises a tetrapod.

15. The concrete structure of claim 1, wherein the concrete structure comprises a seawall.
